(19) United States
(12) Patent Application Publication
(10) Pub. No.: US 2012/0055039 A1
(43) Pub. Date: Mar. 8, 2012

(54) DRYING AND WARMING APPLIANCE

(75) Inventors: Eric K. Watson, Crestwood, KY (US); John K. Besore, Louisville, KY (US); Martin Mitchell Zentner, Prospect, KY (US); Anand Ganesh Joshi, Hyderabad (IN); Subhash Viswanathan Kollengode, Hyderabad (IN); David Scott Dunn, Louisville, KY (US); Lee Fain, Louisville, KY (US); Yogesh Kumar Allimalli, Louisville, KY (US); Sarah Lynn Kirchoff, Hartland, WI (US); Kyle Robert Eden, Louisville, KY (US); Robert Strojan, Louisville, KY (US); Manish Patel, Houston, TX (US); Johnathan James Kroeger, Cincinnati, OH (US); Alicia Abend, York, PA (US); David Duane Warmuth, Louisville, KY (US); Rajesh Narayan Kulkarni, Bangalore (IN)

(73) Assignee: General Electric Company

(21) Appl. No.: 12/877,517

(22) Filed: Sep. 8, 2010

(51) Int. Cl. F26B 25/06

(52) U.S. Cl. 34/218

(57) ABSTRACT

An appliance for drying or warming associated laundry items includes a housing having a wall forming a stationary cavity dimensioned to receive the associated laundry items. At least one article support member is preferably contained within the cavity. A heater increases a temperature of associated air within the cavity and a fan circulates the heated air within the cavity. A vent is dimensioned to allow air to exit the housing cavity, and a controller regulates circulation of the associated heated air within the cavity.

### BACKGROUND OF THE DISCLOSURE

The present disclosure is directed to an article warming or heating appliance including an adjustable article support member provided for interaction with a circulating, preferably heated air current.

Known appliances such as clothes dryers include a housing that contains a drum which rotates as heated air is circulated through the drum to remove moisture from clothes contained therein. The rotation tumbles the clothes and distributes heated air into contact with the articles being warmed or dried. Tumble drying and heat are also hard on some clothing creating lint as a result of the heated tumbling action. For this reason, delicate laundry items are sometimes dry cleaned or air-dried to better preserve the laundry items. Although durable garments can withstand tumble dry cycles, there are times when it is desirable to air dry laundry items including laundry that is deemed delicate.

Traditionally, line drying was a method that used the heat from the sun and air flow to dry garments suspended on an outdoor line. The ability and/or time required to dry an article was obviously dependent on various weather conditions. In other instances, indoor air-drying was an option where the laundry was hung on indoor lines, drying stands, drying racks, etc. These stands included over-the-door hooks, racks, and frames.

One disadvantage associated with these indoor options is the extended drying time because the laundry is not exposed to the sun or elevated temperatures, and there is typically no breeze of warm current of air. In some instances, the hook, rack or stand can be situated next to or in proximity of a heater vent, duct, or passage in an effort to enhance indoor drying. However, under such indoor conditions, the air current generally contacts only one face or surface of the laundry article and not the entire garment.

Still another disadvantage associated with indoor air dry methods is that the garments may smell musty if the laundry dries in a damp area (e.g., basement) or in a manner with insufficient airflow circulated around the garments or laundry items. Thus a need exists for an alternative warming and/or drying appliance which overcomes the noted disadvantages and others and provides for an expedited drying time without causing unnecessary wear on laundry.

### SUMMARY OF THE DISCLOSURE

One exemplary embodiment of the present disclosure is directed toward a drying or warming appliance for laundry or garments that are not tumble dried. The appliance includes a housing having a wall that forms a stationary cavity dimensioned to receive the garments therein. An access is provided to the cavity. At least one article support member is contained within the cavity. At least one heater element is operatively associated with the appliance and increases a temperature of air within the cavity. A fan circulates the heated air within the cavity, while a vent is dimensioned to allow moisture laden air to exit the appliance. A controller regulates circulation of the heated air within the appliance.

Another exemplary embodiment of the present disclosure is directed toward a garment or laundry appliance that warm or dries at least one garment that is supported by an adjustable support member in the cavity.

In one arrangement, the adjustable article support member is a foldable support member having first and second portions interconnected along a hinge.

A sensor may be provided to operatively monitor the cavity and measure the moisture content of at least one associated garment contained within the housing.

The controller receives a signal from the sensor indicative of dryness of the associated garment and the controller regulates the heating element when the associated garment is dry.

The appliance is preferably dimensioned in one exemplary arrangement for use as a pedestal of an associated laundry apparatus, and wherein the housing is manufactured from a material that can serve as a support or stand for the associated laundry apparatus.

A primary advantage associated with the present disclosure is an expedited drying time for laundry garments without tumble drying.

A further advantage associated with the present disclosure relates to the ability to effectively dry more delicate laundry such as finer fabrics, linens, wools, and other laundry items such as shoes, gloves, scarves, ties, etc.

Another advantage associated with the present disclosure is that the drying apparatus has a reduced impact on the laundry items, i.e., reduced wear, fading, or shrinking.

Still another advantage is the ability to function as a warming drawer for laundry items such as towels, etc., while utilizing a fraction of the energy required by a known tumble dryer.

Still other benefits and advantages will be revealed as the exemplary embodiments are described herein.

### BRIEF DESCRIPTION OF THE DRAWINGS

FIG. 1 is a perspective view of an exemplary embodiment of a drying and/or warming appliance according to the present disclosure.

FIG. 2 is a perspective view of another exemplary embodiment according to the present disclosure.

FIG. 3 is a perspective view of still another embodiment including a foldable member dividing the appliance cavity into two unequal sized compartments.

FIG. 4 illustrates conforming the foldable member to divide the appliance cavity into two substantially equal-sized compartments.

FIG. 5 is a perspective view of yet another exemplary embodiment according to the present disclosure.

FIG. 6 is perspective view of another embodiment for supporting laundry items in the appliance cavity.

FIG. 7 is a cross-sectional view of the appliance according to the present disclosure.

FIG. 8 is an illustration of air circulation through a partial side view of the cabinet.

FIG. 9 illustrates a sequence of loading the present disclosure.

### DETAILED DESCRIPTION OF THE PREFERRED EMBODIMENTS

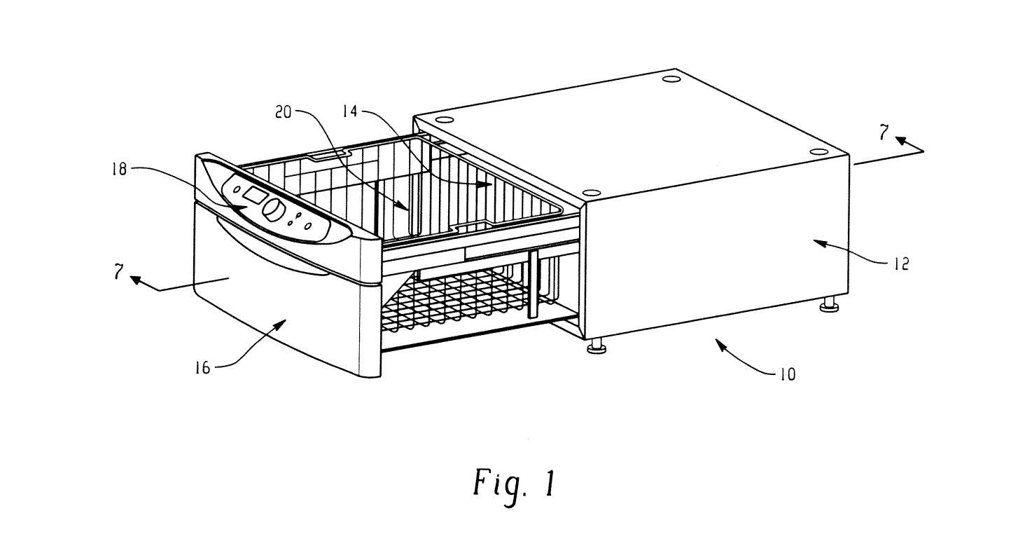

The present disclosure is directed toward a drying and/or warming appliance 10 (sometimes referred to herein as an appliance, dryer, warmer, drying drawer, or drying cabinet) that serves as a supplement to or an alternative for tumble and air drying of laundry (which includes clothing, fabrics, garments, shoes, gloves, and other articles). FIG. 1 generally illustrates the appliance 10 which includes a housing 12 having a rigid wall or walls 12 forming a closed, stationary cavity 14 dimensioned to receive the laundry therein. The appliance 10 preferably takes the form of a stand-alone appliance powered independently or through an adjacent laundry appliance such as a clothes washer or dryer (not shown). The appliance 10 includes a drawer or door 16 providing access to the cavity 14. The drawer moves relative to the housing to provide selective access to the housing interior or cavity and in the preferred arrangement includes a pair of side rails or supports that allow the drawer to extend and retract relative to the housing 12. The housing need not be limited to a drawer but may alternatively take the form of a pivotal door, a sliding door, a top door, and/or a side door. The appliance 10 includes a controller or control panel 18 that is preferably located on an outer surface of the appliance, such as on an outer surface of the housing or on the front surface of the as shown in FIG. 1. As will be appreciated, the control panel includes one or more user inputs such as knobs, switches, buttons, a touch screen interface, display screen, etc. that allow a user such as the homeowner to input selective data or commands (time, temperature, delay, automated selections, etc.) pertaining to operation of the appliance and, in turn, to display certain information.

In one embodiment, the appliance 10 has length and width dimensions that equal a length and/or width dimension of a conventional laundry appliance such as the clothes washer or dryer. In this manner, the appliance 10 is capable of serving as a support or pedestal on which the associated laundry appliance is mounted and supports the laundry appliance above the floor. Consequently, the housing 12 is manufactured from a material of rigid, durable strength such that the drying cabinet can also advantageously function as a laundry appliance stand.

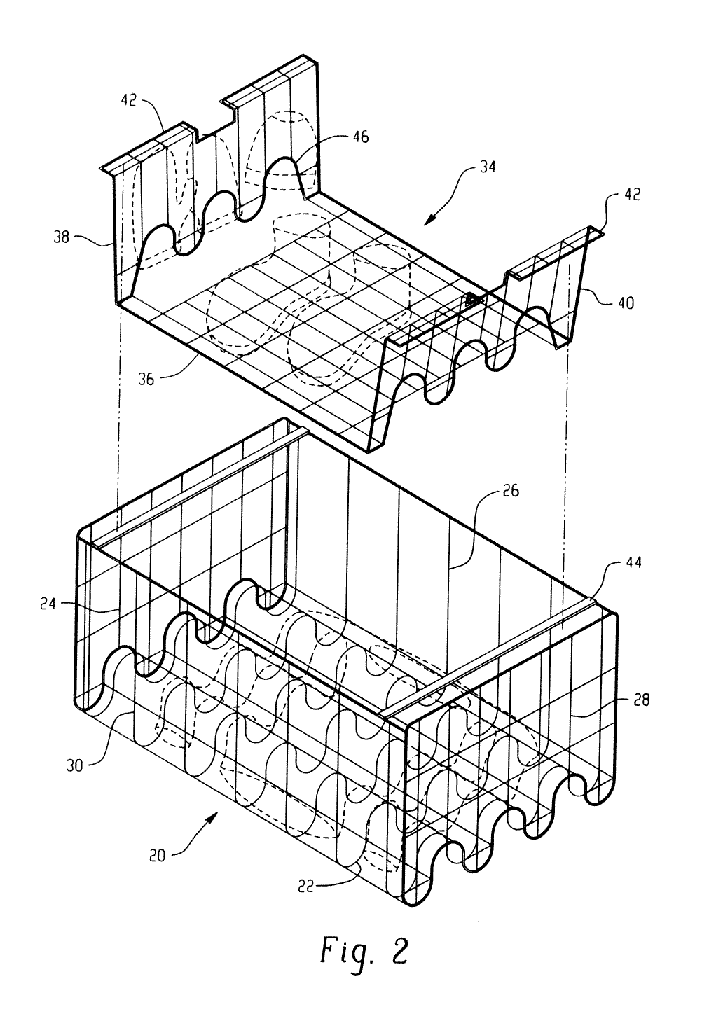

FIG. 2 illustrates an exemplary embodiment of one preferred type of article support member 20 according to the present disclosure. More particularly, the article support member 20 is a wire basket or wire assembly removably received in the drawer or housing, and the article support member is preferably selectively removed from and inserted into the housing cavity 14, e.g., by sliding the drawer with the article support member received therein between an open, accessible position (FIG. 1) and a closed, inaccessible position where the drawer is slid into the housing cavity and generally closed off from the external environment. The illustrated article support member 20 includes a generally horizontal first (i.e., bottom) wall 22 and four generally vertical sidewalls 24, 26, 28, 30 extending from perimeter regions of the bottom wall to form an inner cavity 32. The bottom wall 22 and the sidewalls are desirably formed as an open grid or mesh arrangement, e.g., wire mesh construction, such that air can be easily circulated through the openings in the mesh-like arrangement. This facilitates air flow reaching various surfaces of the laundry that is temporarily stored in the drawer for warming or drying in the appliance. The illustrated article support member 20 may be integrated into the structure of the drawer such as in FIG. 1 where the support member includes at least in part a wave-like bottom wall 22 that maximizes a cross-sectional area that is available on the bottom wall for supporting laundry items such as the illustrated shirt or sweater.

One advantage with the article support member(s) disclosed herein is that additional wire mesh-like supports or rack members 34 can be oriented, stacked, arrayed, nested, etc. within the drawer cavity 32 to increase the number or types of laundry or garments that can be contained in the cavity space (FIG. 2). The rack member or inner rack 34 includes an inner rack bottom wall 36 and at least two opposing inner rack sidewalls 38, 40 extending upwardly therefrom. The inner rack bottom wall 36 has a generally planar member, or may adopt other configurations or conformations that correspond, for example, with the bottom wall 22 of the article support member (i.e., the inner rack bottom wall has corresponding peaks and valleys that nest in the peaks and valleys of the article support member 20).

The first and second inner rack sidewalls 38, 40 are shown to be generally vertical in this arrangement and extend outwardly at a slight angle such that the inner rack can nest within the cavity 32. A flange or lip 42 at an upper or top edge of each inner rack sidewall 40, 42 protrudes outward for supporting, abutting engagement on a corresponding rim 44 of the article support member 20. A support surface or bar 46 is illustrated as a generally curvilinear bar in this embodiment in spaced relation relative from an inner surface of the inner rack sidewalls 38, 40. This is just one preferred configuration and is particularly suitable for smaller articles, such as gloves, mittens, socks, etc., that can be supported in upright orientation on the support bar 46. The curvilinear shape of the bar 46 provides greater support over an area of each small article.

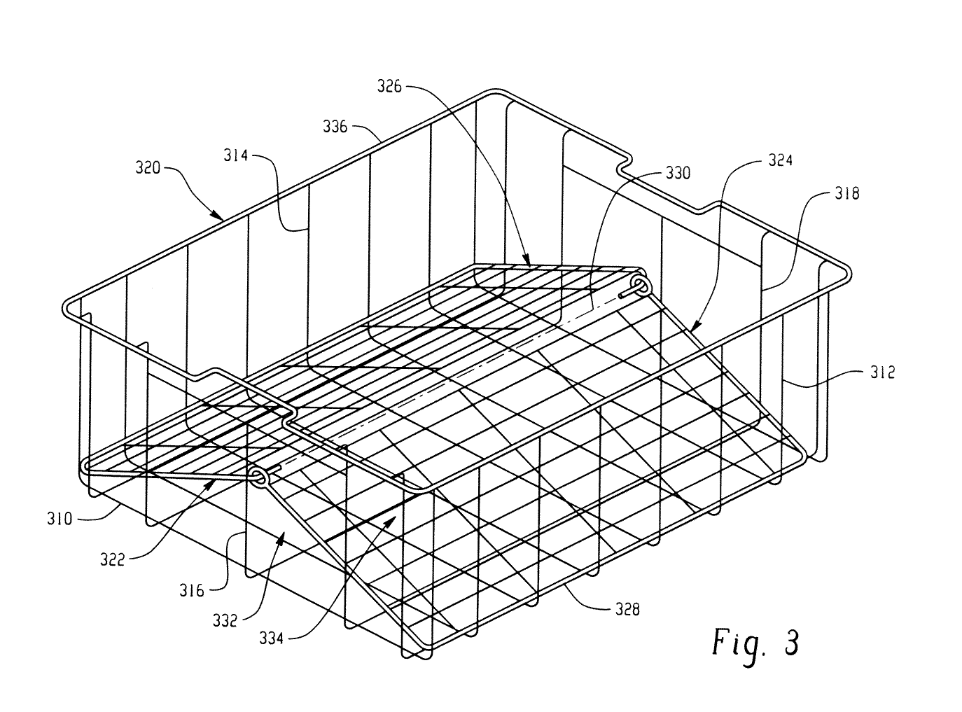

Another exemplary embodiment of an article support member or supplemental article support member 320 is shown in FIG. 3. Specifically, a generally planar bottom wall 310 and four generally vertical sidewalls 312, 314, 316, 318 extend upwardly therefrom to form an inner article containment space 334. The bottom wall 310 and sidewalls are likewise preferably formed of a mesh-like material that is sufficiently durable enough to support laundry articles in the containment space 334 and also permitting air flow through the openings in the mesh. A foldable support member 322 having at least two planar portions 324, 326 are joined along hinge 330 and adapted for selective reconfiguration. The foldable support member 322 is also formed of a mesh-like material such as the wire similar to the remainder of the article support member. The two planar portions 324, 326 extend outwardly from a first edge 328 where a sidewall 312 or 314 meets the bottom wall 310. The opposite second edge 330 of the first planar portion 324 pivotally secures the second planar portion 326 at a hinge. The planar portions 324, 326 are pivoted toward each other. The at least two planar portions 324, 326 function to separate the article containment space into a first article compartment 332 and a second article compartment 334. The first article compartment 332 is formed by the bottom wall 310 and the two planar portions 324, 326. Access to the first article compartment 332 is provided when the first and second planar portions 324, 326 are pivoted relative to one another along the hinge. Thus, the planar portions are disposed in angular orientation to support one or more laundry items thereon. If the illustrated conformation of FIG. 3 is not needed or desired, the planar portions are folded onto one another in a generally planar condition and may be stored on the bottom surface 310.

One advantage associated with the first and second planar portions 324, 326 meeting at a height elevated from the bottom wall 310 is that (i) the combined cross-sectional areas of the portions increase the space available for certain laundry items to be supported thereon or laid across, and (ii) movement of the air through the first article compartment 332 is improved with greater contact with the undersurfaces of the laundry items contained in the second compartment.

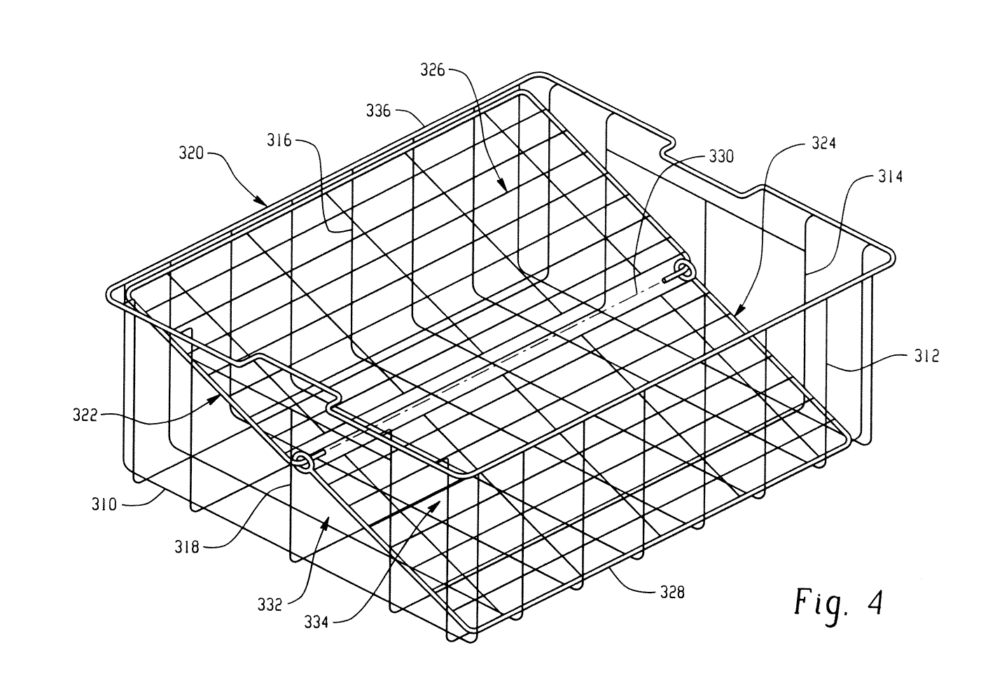

In FIG. 4, the planar portions 324, 326 are oriented in a different manner to support a garment, for example. The article support member 320 of FIG. 4 is conceptually the same and the planar portions are dimensioned so that portions 324, 326 can be angled to divide the cavity into two substantially equally sized portions. In this instance, the planar portions are disposed in substantially co-planar relation and extend across the cavity of the article support member 320 (which may be an insert for the drawer, or in other instances, the drawer itself may serve as the article support member and the planar portions divide the drawer cavity in halves). Again, the article support may be a foraminous construction to aid in circulation of heated or warm air throughout the cavity and over the surfaces of the laundry.

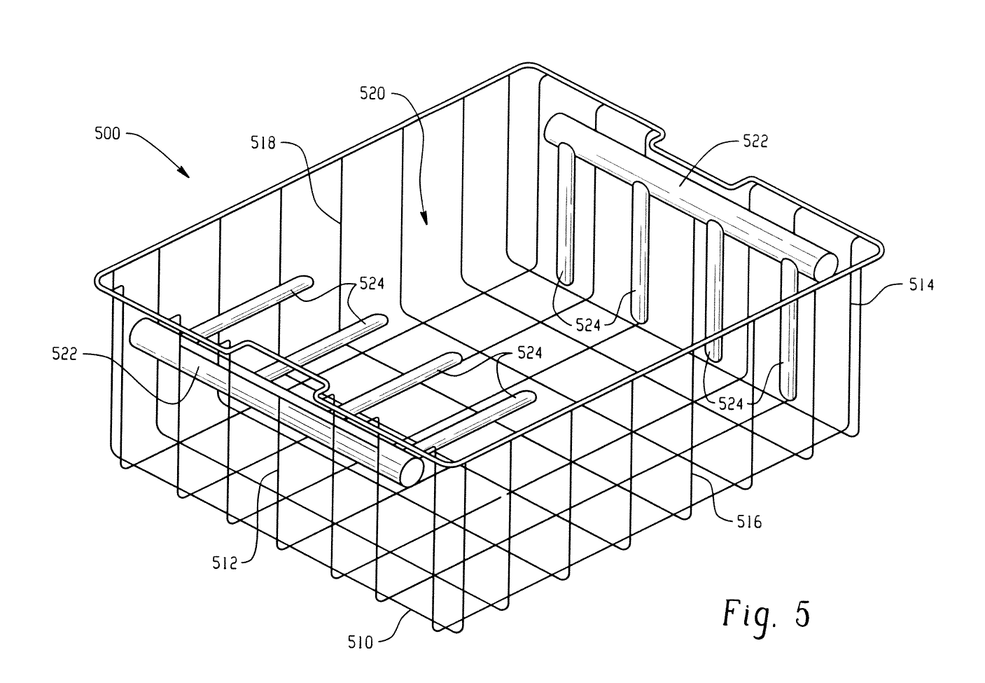

Turning next to FIG. 5, article support member 500 includes at least reconfigurable support that is received in a basket or insert for the drawer, or may be secured directly to the drawer. For example, the support member is shown as a separate insert dimensioned for receipt in the drawer and includes a generally planar bottom wall 510 with four sidewalls 512, 514, 516, 518 extending upwardly from perimeter edges of the bottom wall to form an article containment space (i.e., cavity) 520. As previously discussed, other configurations are contemplated for the walls 510-518 member and the present disclosure should not be limited to the illustrated rectangular cross-sectioned conformation. First and second pivotal support shelves 522 are mounted to opposite facing sidewalls 512, 514. Each support shelf 522 includes a plurality of parallel fingers or support rods 524 that are selectively positioned to lie flat against the respective sidewall or raised upwardly to extend into the cavity and support laundry—e.g., shoes, gloves, garments, socks, etc. In the first or storage position, the support rods lay flat against the adjacent surface of the sidewall. In a second or operative position, the support rods are pivotally extended inward into the article containment space. It is also contemplated that the individual rods can be adapted to pivot in unison or may be individually adjusted relative to one another to offer a wide variety of options to the user and accommodate a wide array of article support configurations.

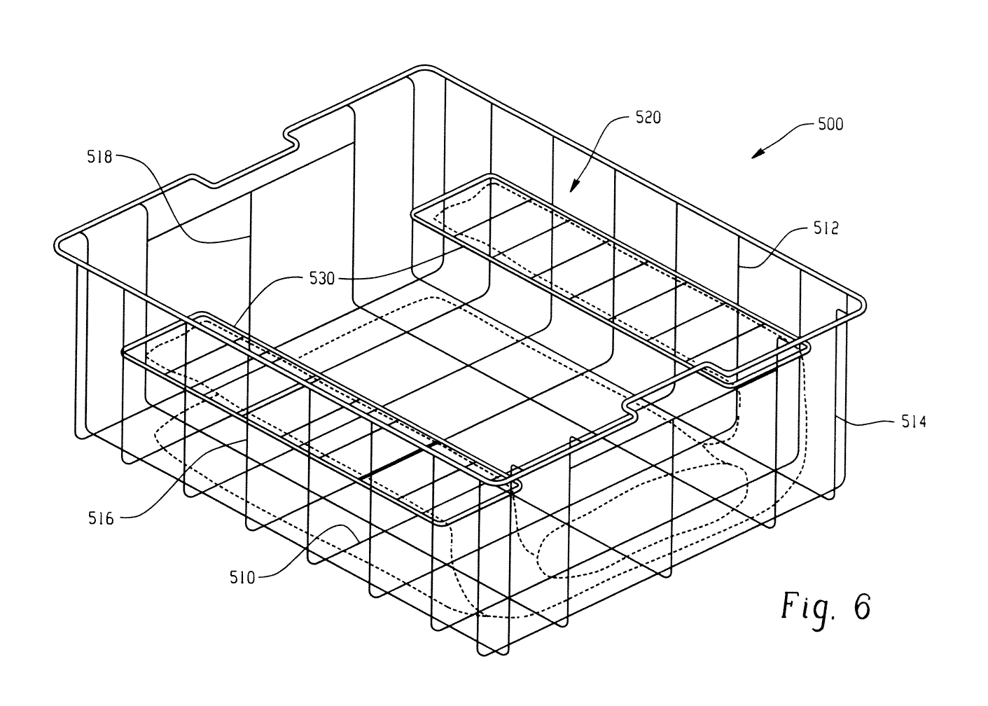

FIG. 6 shows a pair of racks or shelves 530 extending inwardly from the walls of the article support member. The shelves 530 are intended to support the sleeves of a long sleeve garment at a height above the bottom surface of the article support member which receives the remainder of the body of the long sleeved garment (such as a sweater, shirt, coat, etc.). The shelves 530 may be removable or fixed components in the article support member, and like the above-described and illustrated embodiments, demonstrate the versatility. Of course one skilled in the art will recognize that various ones of these article supports can be used individually or in combination, or may come as a kit of removable supports that enhance the range of uses of the appliance.

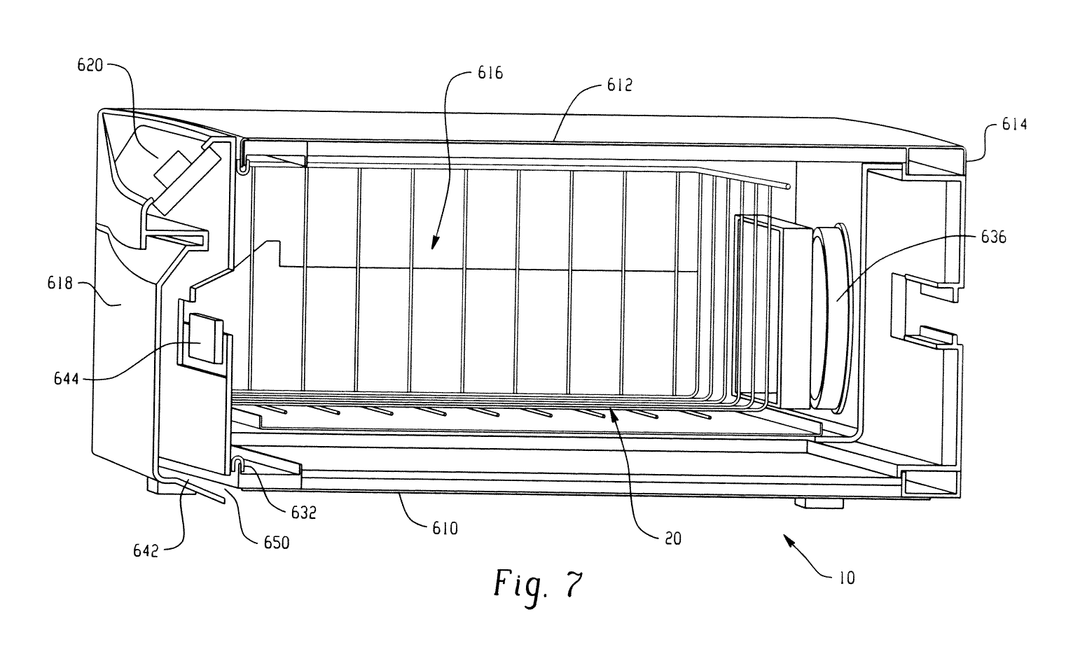

FIG. 7 is across-sectional view of the drying appliance 600 that is constructed in a manner to facilitate air movement within the cavity and around laundry items that are received in the drawer. The appliance housing includes wall portions 610, 612, 614 that enclose a chamber or cavity 616. In the illustrated embodiment, a drawer face 618 or encloses an open end of the housing when in the closed position. The drawer face 618 includes a control panel 620 along a portion thereof which may include suitable inputs and displays as described in association with FIG. 1 to input selective data or commands (time, temperature, delay, automated selections, etc.) pertaining to operation of the appliance and, in turn, to display certain information. The control panel includes a controller that is in operative communication with a control board 622 for controlling a heater, fan, sensor, etc. to control of air movement, air intake, temperature, etc. within the appliance chamber. The drawer provides selective access to the appliance chamber to insert and retrieve selected laundry items.

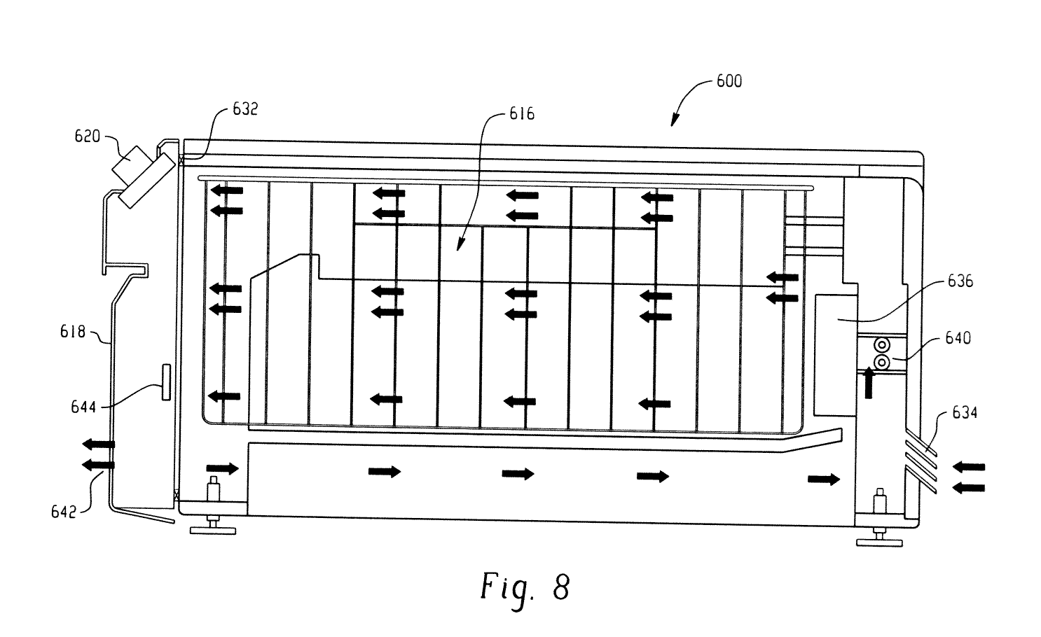

The appliance 600 may include thermal insulation, for example, along one or more wall portions of the housing. A gasket 632 is preferably formed around the front opening of the appliance housing to seal with the drawer when the drawer is closed. An air inlet 634 is shown as extending through a rear wall portion so that ambient air is pulled into the cabinet by a fan 636. A heating element or heater 640 (FIG. 8) is disposed in the flow path to heat or warm the air as needed. The heater 640 can be selectively activated to heighten a temperature of the air flow through the cavity such that the laundry articles contained in the article containment space are warmed or dried faster. As the warm air current comes into contact with the articles contained in the article support member, moisture is transferred from the laundry articles to the circulating air and exits the housing through one or more outlets 642. Air is guided from the rear of the appliance toward a front of the drawer where the moist air is guided through a damper or a fixed orifice 644 and downward for egress from the cabinet. Some air may be directed for recirculation or return toward the fan where the recirculation flow joins with inlet air for passage through the cavity. As will be appreciated, the position of the damper or size of the fixed orifice determines what percentage of the air flow is recirculated toward a rear of the cabinet.

Preferably both the inlet and exhaust ports are situated at a point substantially lower than the laundry articles to be dried. This arrangement enables the design to minimize natural convection air exchange with the installation environment when the fan is off.

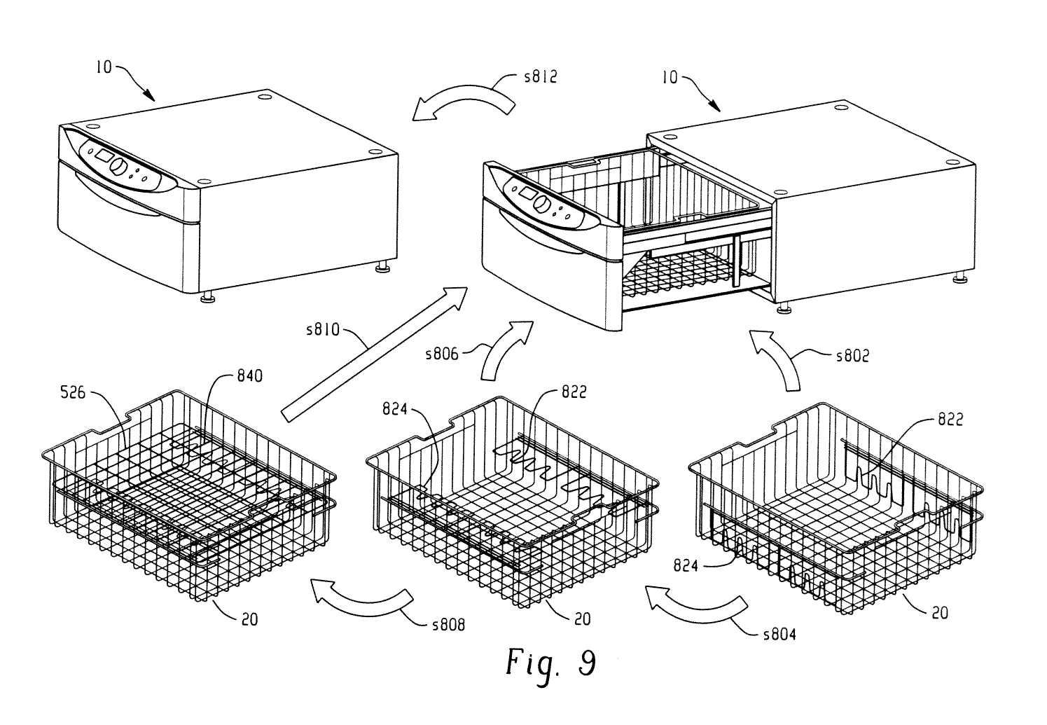

FIG. 9 is utilized herein to demonstrate a sequence for loading the article support member 20 into the drying appliance 10. At least one laundry item or garment can be placed in the cavity of the article support member 20, and the article support member can be placed into the drawer portion of the appliance 10, as is shown as step s802. A first step s804 in the loading sequence includes configuring, positioning, or moving the support shelves 822, 824 from the first position (retracted) to a second (extended) position, wherein the shelves pivot such that the fingers extend outwardly from the inner sidewall. At least one garment can be placed in the article support member 20. Similarly, shoes can be placed into the cavity in a standing manner such that a finger of the support shelf supports a shoe in an upright position. The article support rack can be directly inserted into the drawer of the appliance as is shown as step s806.

If the fingers are not used to support any particular article, the shelves can be used to support a generally planar support member 840 resting thereon. Once the desired laundry items are placed in the article support member, the rack is placed in the drawer. By using the planar support member, a second layer laundry items can be placed in the article support member 20 to maximize utilization of the appliance. After the layers of garments or laundry items are situated in the cavity, the article support member is placed in a corresponding drawer cavity (step s810) of an opened drawer in the appliance 10. In the illustrated embodiment, access to the appliance 10 includes a drawer that slides relative to the housing in a manner well known in the art.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. An appliance for drying or warming associated laundry, the appliance comprising:
a housing including a wall forming a stationary cavity dimensioned to receive the associated laundry therein;
an access to the cavity;
at least one article support member contained within the cavity;
at least one heater element to increase a temperature of associated air within the cavity;
a fan for circulating associated heated air within the cavity;
an inlet and exhaust vent dimensioned to allow air exchange between the cavity and an associated installation environment; and
a controller for regulating circulation of the associated heated air within the cavity.

2. The appliance of claim 1, further including a removable support insert.

3. The appliance of claim 1, wherein at least a portion of the housing wall that surrounds the cavity has a curvilinear conformation.

4. The appliance of claim 1, wherein the at least one article support member is adjustable.

5. The appliance of claim 4, wherein the at least one adjustable article support member is a foldable support member having first and second portions interconnected along a hinge.

6. The appliance of claim 5, wherein the foldable support member is dimensioned to span the cavity along a diagonal dimension.

7. The appliance of claim 5, wherein the foldable support member is dimensioned so that one edge of the first and second portions are situated about a perimeter of a bottom surface of the cavity, and the first and second portions are disposed at an included angle greater than 90°.

8. The appliance of claim 5, wherein the first and second portions of the foldable support member have a combined surface area greater than a surface area of a bottom of the housing.

9. The appliance of claim 1, further comprising an intake port for delivery of the associated dry air, wherein the intake port and the vent are situated on opposite sidewalls of the housing.

10. The appliance of claim 1, further including a sensor operatively monitoring the cavity for measuring at least one variable associated with dryness of at least one laundry item contained within the cavity.

11. The appliance of claim 10, wherein the controller receives a signal from the sensor indicative of dryness of the associated laundry contained within the cavity and the controller regulates the heating element when the associated laundry is dry.

12. The appliance of claim 1, wherein the controller maintains a temperature range of the heating element.

13. The appliance of claim 12, wherein the heating element increases a temperature of the associated heated air circulating in the cavity up to and no greater than approximately 140° F. (60° C.).

14. The appliance of claim 1, wherein the appliance is dimensioned for use as a pedestal portion of an associated laundry apparatus, and wherein the housing is manufactured from a material that can support the associated laundry apparatus as a laundry appliance stand.

15. A drying or warming apparatus for at least one associated laundry item, comprising:
a housing including a stationary cavity dimensioned to receive the associated laundry item therein;
at least one access to an interior of the cavity;
at least one adjustable support member contained within the cavity; and,
at least one heater element to increase a temperature of associated air within the cavity.

16. The drying apparatus of claim 15, wherein the circulation means includes:
an inlet situated on the housing at a height elevated from a lowest portion of the housing;
a fan for circulating associated heated air within the cavity;
a controller for regulating circulation of the associated heated air within the cavity; and,
an inlet and exhaust vent dimensioned to allow air exchange between the cavity and an associated installation environment.

17. The drying apparatus of claim 16, further including a sensor situated within the cavity for measuring at least one variable associated with moisture content of at least one associated laundry item contained within the cavity, wherein the controller receives a signal from the sensor and uses the signal value to determine if the associated laundry item contained within the cavity is dry.

18. The drying apparatus of claim 16, wherein the controller deenergizes the heating element when the associated laundry item is dry or the chosen cycle has ended.

19. The drying apparatus of claim 16 wherein the inlet is below the height of the clothes load in the cavity and the exhaust opening is lower than the laundry items.

20. The garment drying cabinet of claim 16, wherein the controller maintains a temperature range of the associated heated air circulating in the cavity up to approximately and preferably no greater than 140° F. (60° C.) based on a user-input for a fabric type of the associated laundry item supported by the rack.
